(19) United States
(12) Patent Application Publication
(10) Pub. No.: US 2012/0313898 A1
(43) Pub. Date: Dec. 13, 2012

(54) TOUCH-SENSITIVE DEVICE

(75) Inventors: Chia-Hsiung Chang, Tainan City (TW); Tsung-Yen Hsieh, Taichung City (TW); Chia-Hung Yeh, Shetou Township (TW); Jyh-Yeuan Ma, Taoyuan City (TW)

(73) Assignees: WINTEK CORPORATION, Taichung City (TW); WINTEK (CHINA) TECHNOLOGY LTD., Dongguan City (CN)

(21) Appl. No.: 13/490,104

(22) Filed: Jun. 6, 2012

(30) Foreign Application Priority Data
Jun. 7, 2011 (TW) 100119884

(51) Int. Cl. G06F 3/042

(52) U.S. Cl. 345/175

(57) ABSTRACT

A touch-sensitive device including a display, a set of solar cells and a set of light sensors is provided. The display includes an external frame and a display panel. The external frame is located around the display panel. The set of solar cells is disposed within the external frame and applied to form a set of infrared light sources in the state of electro-luminescence. The set of light sensors is disposed within the external frame for receiving a corresponding light emitted by the set of infrared light sources.

This application claims the benefit of Taiwan application Serial No. 100119884, filed Jun. 7, 2011, the subject matter of which is incorporated herein by reference.

### BACKGROUND OF THE INVENTION

1. Field of the Invention

The invention relates in general to a touch-sensitive device, and more particularly to a touch-sensitive device using solar cells in the state of electro-luminescence.

2. Description of the Related Art

Ever since the touch panel technology is developed, the touch panel has always had a very high market share among consumer electronic products. Currently, the touch display panel integrating touch function and display function is provided and used in portable consumer electronic products such as wireless communication mobile phones, notebook computers, tablet computers and digital cameras.

Let the optical touch panel be taken for example. The optical touch panel includes a display, a set of light sources and a set of sensors. In general, the light sources and the sensors are disposed above the display and beside the display screen. When an object, such as a user's finger or a stylus, is within the area of the display screen, a part of the light emitted by the light sources is blocked by the object. Thus, the coordinates of the object in the display screen can be determined according to the image received by the sensors.

In order to precisely determine the coordinates of the object on the display screen so as to increase the resolution, the conventional optical touch panel has tens of light emitting diodes disposed around the screen to form a set of web-like light sources. The higher the density of the light emitting diodes, the more optical signals can pass per unit area, and the easier the recognition of the position of the object. When the screen is touched, the light emitted by the light emitting diodes is blocked and shadows are generated on the reflection strips, and the image received by the sensors are not complete optical signals but a fragmented optical signal divided into pieces by the shadows. Meanwhile, the position of the reflection strip blocked by the shadows can be obtained by the touch circuit through logic computation for determining the actual coordinates of the object. However, if some light emitting diodes happen to break down, the sensors may misinterpret that the light from the broken light emitting diodes are blocked and therefore generate shadows. As a result, the image received by the sensors is distorted, and the accuracy of judgment in determining the touch position is affected or may even fail.

Since the light emitting diodes are a point-like light source and are assembled independently, the larger the number of light emitting diodes is, the higher the manufacturing cost will be. Even the assembled light emitting diodes are tightly arranged together, the determination of accurate touch positioning still depends on the reflection strips. The entire set of light emitting diodes needs to be replaced or repaired if some light emitting diodes happen to break down, making the maintenance more complicated and expensive.

### SUMMARY OF THE INVENTION

The invention is directed to a touch-sensitive device which generates a light with the solar cells in the state of electro-luminescence, and further performs touch positioning in cooperation with the light sensors. Since the solar cells have low energy gap, the solar cells receiving a forward bias can emit a light of specific wave-length, and can be used as a linear light source of the optical touch-sensitive device.

According to an aspect of the present invention, a touch-sensitive device including a display, a set of solar cells and a set of light sensors is provided. The display includes an external frame and a display panel. The external frame is located around the display panel. The set of solar cells is disposed within the external frame and applied to form a set of infrared light sources in the state of electro-luminescence. The set of light sensors is disposed within the external frame for receiving a corresponding light emitted by the set of infrared light sources.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 shows a relationship diagram of output current vs. luminance per unit area when solar cells are radiated;

FIG. 2 shows a relationship diagram of output current vs. corresponding voltage after an external voltage is applied to the solar cells;

FIG. 3 shows a spectrogram of the light emitted by solar cells in the state of electro-luminescence according to one embodiment of the invention;

FIGS. 4A and 4B shows a top view of a touch-sensitive device according to one embodiment of the invention and a partial cross-section view of the touch-sensitive device along a line segment I-I;

FIG. 5 shows a top view of a touch-sensitive device according to one embodiment of the invention; and

FIG. 6 shows a top view of a touch-sensitive device according to one embodiment of the invention.

### DETAILED DESCRIPTION OF THE INVENTION

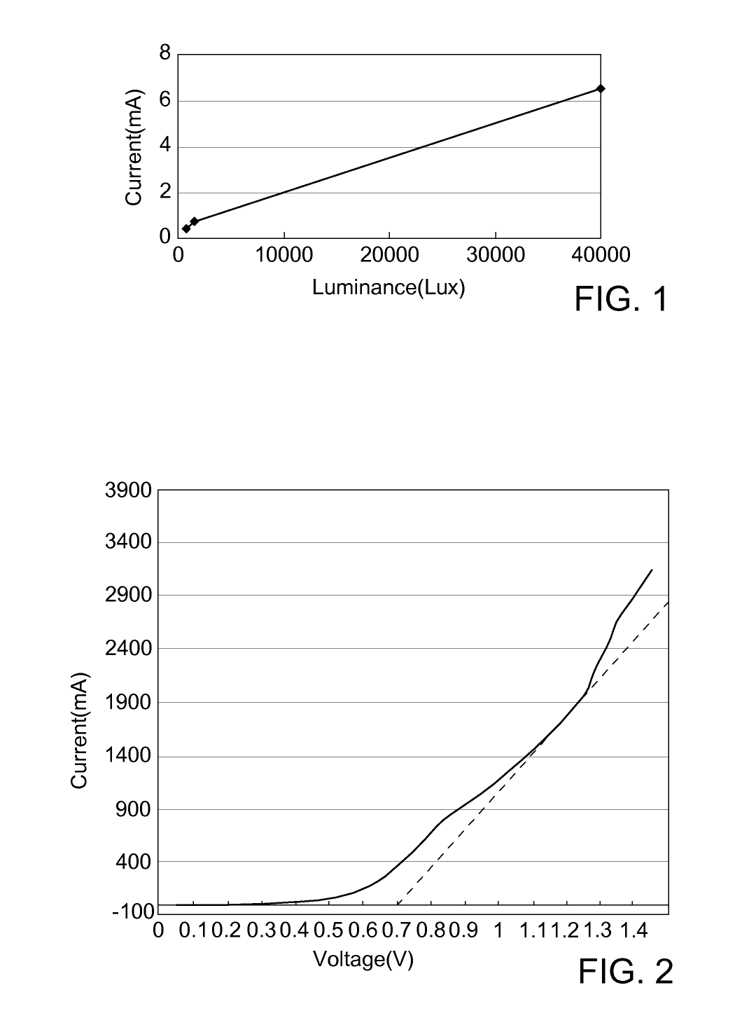

The touch-sensitive device of the present embodiment of the invention illuminates with solar cells in the state of electro-luminescence. The solar cells can be exemplified by mono-crystalline silicon solar cells, poly-crystalline silicon solar cells or amorphous silicon solar cells. In general, solar cells are formed by semiconductor materials with different energy gaps according to a semiconductor process. When the energy of the light is larger than the energy gap, free electron-hole carrier pairs are generated in the semiconductor material, and holes and electrons respectively flow to different polarities through the effect of electric field between P-type semiconductor (positive polarity) and N-type semiconductor (negative polarity) to form a current whose magnitude ranges about from hundreds of microampere to a number of milliampere (mA) as indicated in FIG. 1. FIG. 1 shows a relationship diagram of output current vs. luminance per unit area when solar cells are radiated.

In the absence of the radiation of the light, a forward bias is applied to the solar cells so that the solar cells emit a light of a specific wave-length. Meanwhile, as long as the forward bias is larger than the voltage at the P-N junction of the solar cells, the electrons and the holes are combined and the energy for combining the electrons and the holes is released in the form of a light. Referring to FIG. 2, a relationship diagram of output current vs. corresponding voltage after an external voltage is applied to the solar cells is shown. A comparison of current between FIG. 1 and FIG. 2 shows that the current (such as 3000 mA) generated by the solar cells when receiving an external voltage (such as 1.4V) is far larger than the current (about 10 mA) generated by the solar cells when being radiated by a light. In order to reduce background noise from external light, a high-pass optical filter is allowed being attached on solar cell for eliminating visible light spectra. Therefore, it can be assured that the solar cells can be used as a linear light source in the touch-sensitive device of the present embodiments and is not affected by the radiation of the sun light.

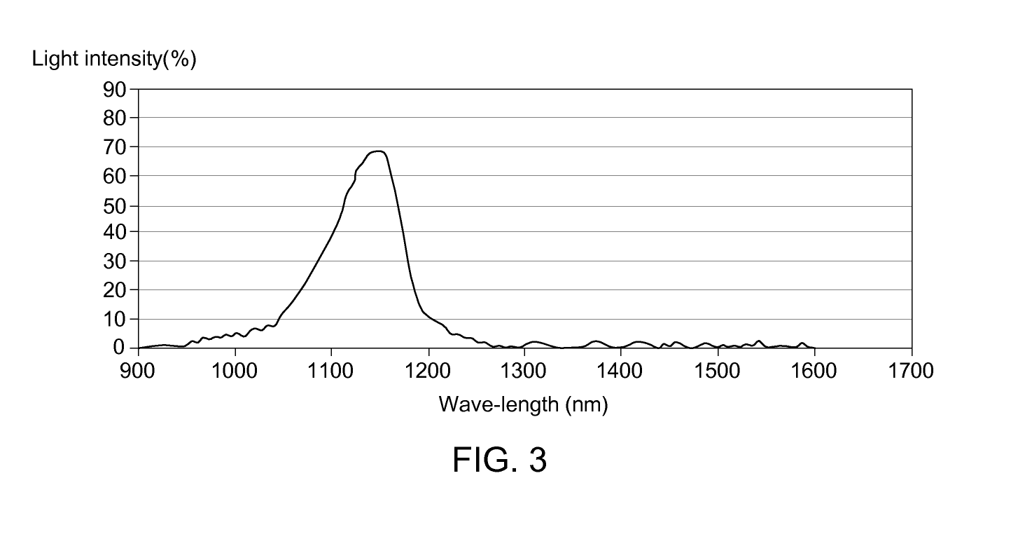

Referring to FIG. 3, a spectrogram of the light emitted by solar cells in the state of electro-luminescence according to one embodiment of the invention is shown. The wave-length of the infra-red light spectrum ranges between 950˜1250 nm with the central wave-length being about 1150 nm. Therefore, touch positioning can be performed by the light sensor with the infra-red light generated by the solar cells in the state of electro-luminescence for accurately detecting the coordinates of an object such as a user's finger or a stylus.

A number of embodiments are disclosed below for elaborating the invention. However, the embodiments of the invention are for detailed descriptions only, not for limiting the scope of protection of the invention.

### First Embodiment

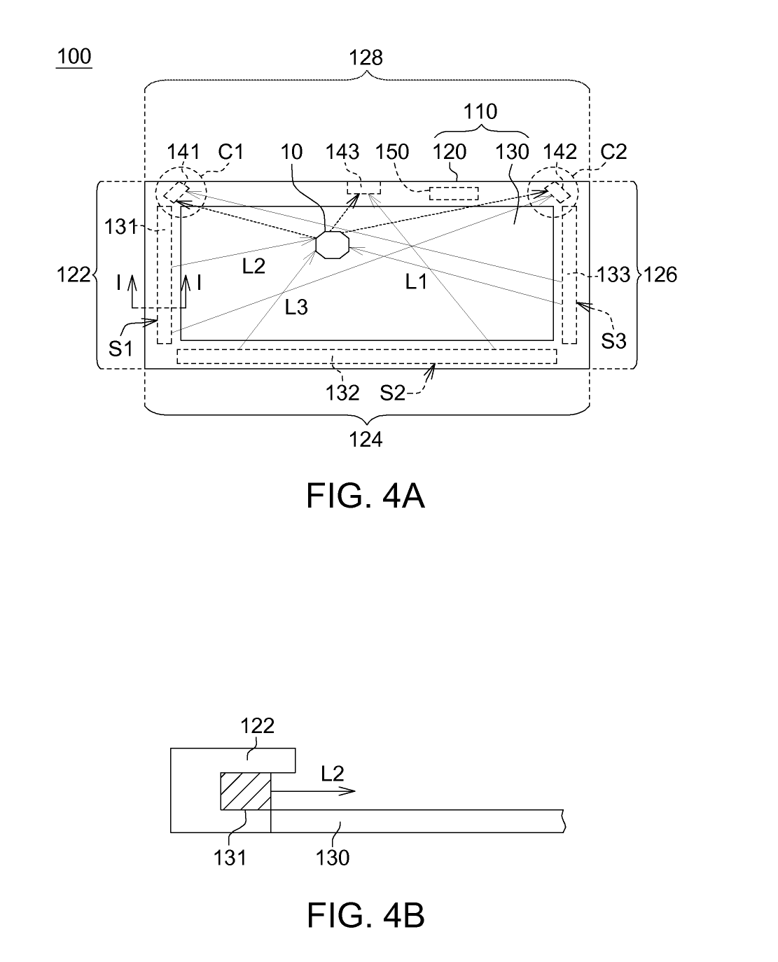

Referring to FIGS. 4A and 4B, a top view of a touch-sensitive device according to one embodiment of the invention is shown in FIG. 4A and a partial cross-section view of the touch-sensitive device along a line segment I-I of FIG. 4A is shown in FIG. 4B. Let a set of infrared light sources S1˜S3 formed by three solar cells 131˜133 be taken for example. The touch-sensitive device 100 includes a display 110, three solar cells 131-133 and a set of light sensors 141˜143. The display 110 includes an external frame 120 and a display panel 130. The external frame 120 is located around the display panel 130. Each solar cell is disposed within a frame body of the external frame 120. Each solar cell in the state of electro-luminescence is used as an infrared light source, and the number of infrared light sources is exemplified by 3 but the invention is not limited thereto. Each light sensor is disposed within the external frame 120 for receiving the light emitted by a corresponding infrared light source.

In the present embodiment, the solar cells such as strip cells are respectively disposed within a frame body of the external frame 120. The external frame 120, such as a quadrilateral frame, includes a first frame body 122, a second frame body 124, a third frame body 126, a fourth frame body 128, a first corner C1 and a second corner C2. As indicated in FIG. 4A, the first solar cell 131 is disposed within the first frame body 122 of the external frame 120, the second solar cell 132 is disposed within the second frame body 124 of the external frame 120, the third solar cell 133 is disposed within the third frame body 126 of the external frame 120 and is opposite to the first solar cell 131. In addition, the set of light sensors includes a first sensor 141 and a second sensor 142, wherein the first sensor 141 is disposed at the first corner C1 adjacent to the first frame body 122, and the second sensor 142 is disposed at the second corner C2 adjacent to the third frame body 126. The first corner C1 and the second corner C2 respectively are located on two opposite sides of the fourth frame body 128 of the external frame 120. In addition, the set of light sensors further includes a third sensor 143 disposed within the fourth frame body 128 and between the first sensor 141 and the second sensor 142.

As indicated in FIG. 4A, the touch-sensitive device 100 further includes a processor 150 electrically connected to each light sensor. When an object 10 is located within the area of the display screen, a part of the lights (for example, at least two of the lights L1˜L3 illustrated in dotted lines) emitted by the infrared light source is blocked by the object 10. The processor 150 determines the coordinates of the object 10 on the display screen according to the image received by the light sensor and accordingly outputs a coordinate signal. Since the solar cells of the present embodiment are strip-shaped infrared light sources and the light sensors 141˜143 working with the solar cells are a set of infra-red cameras, the touch circuit performs logic computation on the image received by the light sensors 141˜143, and the coordinates of the object 10 can be obtained without forming shadows on the generally known reflection strips.

### Second Embodiment

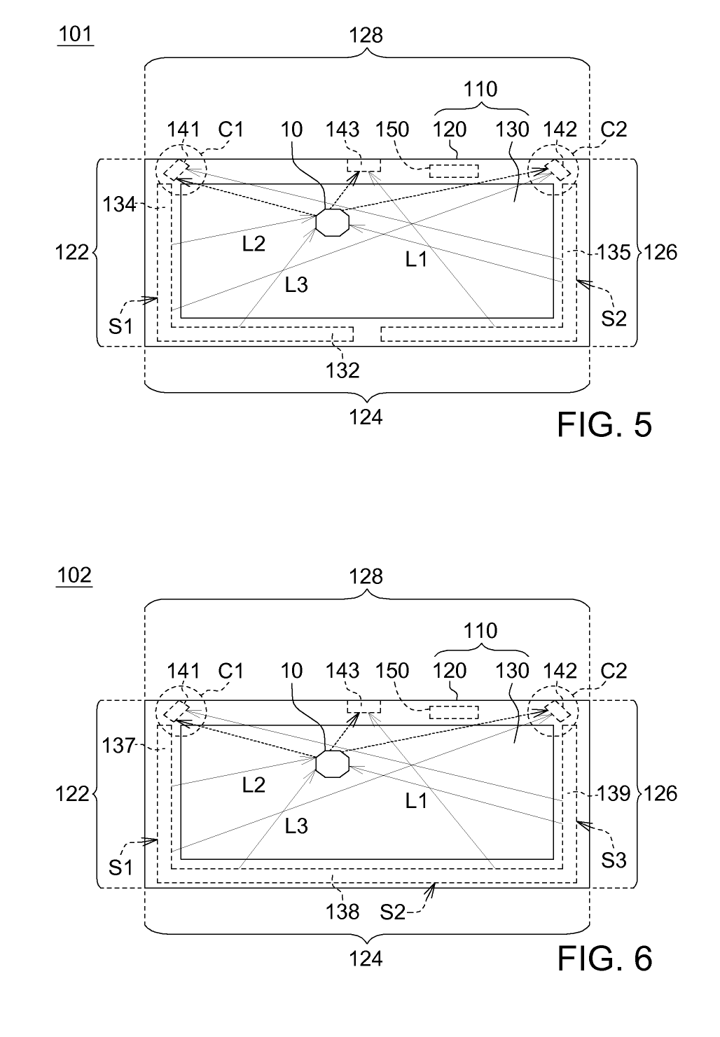

Referring to FIG. 5, a top view of a touch-sensitive device according to one embodiment of the invention is shown. Let a set of infrared light sources S1˜S2 formed by two solar cells 134˜135 be taken for example. The touch-sensitive device 101 includes a display 110, two solar cells 134˜135 and a set of light sensors 141˜143. The display 110 includes an external frame 120 and a display panel 130. The external frame 120 is located around the display panel 130. Each solar cell is disposed within a frame body of the external frame 120. Each solar cell in the state of electro-luminescence is used as an infrared light source, and the number of infrared light sources is exemplified by 2 but the invention is not limited thereto. Each light sensor is disposed within the external frame 120 for receiving the light emitted by a corresponding infrared light source.

In the present embodiment, the solar cells such as L-shaped cells are respectively disposed within two adjacent frame bodies of the external frame 120. The external frame 120, such as a quadrilateral frame, includes a first frame body 122, a second frame body 124, a third frame body 126, a fourth frame body 128, a first corner C1 and a second corner C2. As indicated in FIG. 5, the first solar cell 134 is disposed within the first frame body 122 and the second frame body 124 adjacent to each other, and is opposite to the second corner C2 in a diagonal direction. The second solar cell 135 is disposed within the second frame body 124 and the third frame body 126 adjacent to each other, and is opposite to the first corner C1 in a diagonal direction. In addition, the set of light sensors includes a first sensor 141 and a second sensor 142, wherein the first sensor 141 is disposed at the first corner C1 adjacent to the first frame body 122, and the second sensor 142 is disposed at the second corner C2 adjacent to the third frame body 126. The first corner C1 and the second corner C2 respectively are located on two opposite sides of the fourth frame body 128 of the external frame 120. In addition, the set of light sensors further includes a third sensor 143 disposed within the fourth frame body 128 and between the first sensor 141 and the second sensor 142.

As indicated in FIG. 5, the touch-sensitive device 100 further includes a processor 150 electrically connected to each of light sensors 141˜143. When an object 10 is located within the area of the display screen, a part of the lights (for example, at least two of the lights L1˜L3 illustrated in dotted lines) emitted by the infrared light source is blocked by the object 10. The processor 150 determines the coordinates of the object 10 on the display screen according to the image received by the light sensor and accordingly outputs a coordinate signal. Since the solar cells of the present embodiment are L-shaped infrared light sources and the light sensors 141˜143 working with the solar cells are a set of infra-red cameras, the touch circuit performs logic computation on the image received by the light sensors 141˜143, and the coordinates of the object 10 can be obtained without forming shadows on the generally known reflection strips.

### Third Embodiment

Referring to FIG. 6, a top view of a touch-sensitive device according to one embodiment of the invention is shown. The present embodiment is different from the first and the second embodiment in that the present embodiment has only one solar cell. For example, the solar cell made from a flexible cell film can be cut into any shapes and attached on the inner walls of the external frame 120 according to the shape of the display 110. As indicated in FIG. 6, the solar cells such as U-shaped cells are disposed within three adjacent frame bodies of the external frame 120. The external frame 120, such as a quadrilateral frame body, includes a first frame body 122, a second frame body 124, a third frame body 126, a fourth frame body 128, a first corner C1 and a second corner C2. As indicated in FIG. 6, the U-shaped cell includes a first cell portion 137, a second cell portion 138 and a third cell portion 139 which are interconnected with each other with each other. The first cell portion 137 is disposed within the first frame body 122 of the external frame 120, the second cell portion 138 is disposed within the second frame body 124 of the external frame 120, and the third cell portion 139 is disposed within the third frame body 126 of the external frame 120 and is opposite to the first cell portion 137. Besides, the set of light sensors includes a first sensor 141 and a second sensor 142, wherein the first sensor 141 is disposed at the first corner C1 adjacent to the first cell portion 137, and the second sensor 142 is disposed at the second corner C2 adjacent to the third cell portion 139. The first corner C1 and the second corner C2 respectively are located on two opposite sides of the fourth frame body 128 of the external frame 120. Besides, the set of light sensors further includes a third sensor 143 disposed within the fourth frame body 128 and between the first sensor 141 and the second sensor 142.

The touch positioning of the touch-sensitive device 102 of the third embodiment is similar to the touch positioning of the first and the second embodiments, and the similarities are not repeated here. Noted that in each of the above embodiments, the coordinate signal outputted from the processor 150 can be converted into a corresponding display signal by the control circuit of the display panel 130, and further outputted to the display panel 130 for displaying picture frames. The display panel 130 can be realized by such as cold cathode ray (CCR) display panel, liquid crystal display (LCD) panel, plasma display panel or organic light emitting diode (OLED) display panel. The display signal is such as a cursor signal, a click signal or a drag signal. Thus, the user can perform touch control via the display screen.

Besides, in each of the above embodiments, the solar cells illuminate in the state of electro-luminescence, and touch positioning is performed in cooperation with the light sensors. The solar cells being linear light sources can be cut into any shapes (such as strip, L-shape, U-shape or a combination thereof), so the number of light emitting diodes used as light sources can be reduced. Furthermore, the reflection strips are not used, so the assembly cost and the maintenance cost are both reduced.

Despite three light sensors are used as an exemplification in each of the above embodiments, the position of the object can be detected with only two light sensors such as the first sensor and the second sensor located at the first corner and the second corner respectively. Thus, the number of light sensors can be adjusted according to the sensitivity and accuracy of detection. When three light sensors are used, the blind angles can be reduced and the accuracy of logic computation can be increased. The number of light sensors is not limited to three, and the larger the number of light sensors, the better the performance.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch-sensitive device, comprising:
a display comprising an external frame and a display panel, wherein the external frame is located around the display panel;
a set of solar cells disposed within the external frame and applied to form a set of infrared light sources in the state of electro-luminescence; and
a set of light sensors disposed within the external frame for receiving a corresponding light emitted by the set of infrared light sources.

2. The touch-sensitive device according to claim 1, further comprising a processor electrically connected to the set of light sensors, wherein when at least two lights emitted by the set of light sources are blocked by an object and are not received the set of light sensors, and the processor determines the position of the object and outputs a coordinate signal.

3. The touch-sensitive device according to claim 1, wherein the set of solar cells has a plurality of strip cells, the external frame has a first frame body, a second frame body, a third frame body and a fourth frame body which are interconnected with each other in order, and the strip cells comprise:
a first solar cell disposed within the first frame body of the external frame;
a second solar cell disposed within the second frame body of the external frame; and
a third solar cell disposed within the third frame body of the external frame and opposite to the first solar cell.

4. The touch-sensitive device according to claim 3, wherein the set of light sensors is disposed within the fourth frame body of the external frame.

5. The touch-sensitive device according to claim 4, wherein the external frame has a first corner adjacent to the first frame body and a second corner adjacent to the third frame body, the first corner and the second corner respectively are located on two opposite sides of the fourth frame body of the external frame, and the set of light sensors comprises a first sensor disposed at the first corner and a second sensor disposed at the second corner.

6. The touch-sensitive device according to claim 5, wherein the set of light sensors further comprises a third sensor disposed between the first sensor and the second sensor.

7. The touch-sensitive device according to claim 1, wherein the set of solar cells has a plurality of L-shaped cells, the external frame has a first frame body, a second frame body, a third frame body and a fourth frame body which are interconnected with each other in order, and the L-shaped cells comprise:
a first solar cell disposed within the first frame body and the second frame body adjacent to each other; and
a second solar cell disposed within the second frame body and the third frame body adjacent to each other.

8. The touch-sensitive device according to claim 7, wherein the set of light sensors is disposed within the fourth frame body of the external frame.

9. The touch-sensitive device according to claim 8, wherein the external frame has a first corner adjacent to the first frame body and a second corner adjacent to the third frame body, the first corner and the second corner respectively are located on two opposite sides of the fourth frame body of the external frame, and the set of light sensors comprises a first sensor disposed at the first corner and a second sensor disposed at the second corner.

10. The touch-sensitive device according to claim 9, wherein the set of light sensors further comprises a third sensor disposed between the first sensor and the second sensor.

11. The touch-sensitive device according to claim 1, wherein the set of solar cells has a U-shaped cell, the external frame has a first frame body, a second frame body, a third frame body and a fourth frame body which are interconnected with each other in order, the U-shaped cell comprises a first cell portion, a second cell portion and a third cell portion which are interconnected with each other, the first cell portion is disposed within the first frame body of the external frame, the second cell portion is disposed within the second frame body of the external frame, and the third cell portion is disposed within the third frame body of the external frame and opposite to the first cell portion.

12. The touch-sensitive device according to claim 11, wherein the set of light sensors is disposed within the fourth frame body of the external frame.

13. The touch-sensitive device according to claim 12, wherein the external frame has a first corner adjacent to the first frame body and a second corner adjacent to the third frame body, the first corner and the second corner respectively are located on two opposite sides of the fourth frame body of the external frame, and the set of light sensors comprises a first sensor disposed at the first corner and a second sensor disposed at the second corner.

14. The touch-sensitive device according to claim 13, wherein the set of light sensors further comprises a third sensor disposed between the first sensor and the second sensor.
